(19) United States
(12) Patent Application Publication
(10) Pub. No.: US 2011/0067967 A1
(43) Pub. Date: Mar. 24, 2011

(54) Method and Apparatus for Locking a Rollable Suitcase

(76) Inventor: Peter-Paul R. Herrera, Westminster, CO (US)

(21) Appl. No.: 12/562,666

(22) Filed: Sep. 18, 2009

(51) Int. Cl. A45C 5/14; A45C 13/00; E05B 65/52; A45C 13/10

(52) U.S. Cl. 190/18 A; 190/115; 70/69; 16/405

(57) ABSTRACT

Described herein is a suitcase having a locking mechanism disposed on the handle of the suitcase according to embodiments. The suitcase has a plurality of wheels disposed on a distal end. A casing is at least partially disposed on a first side of the suitcase. At least one extendable arm is slideably coupled to the casing and the arm is configured to move between a retracted position and an extended position. A handle is coupled to the at least one arm and a button is disposed on the handle. When the button is depressed, the handle can be moved from the retracted position to an extended position. A locking mechanism is also disposed on the handle which prohibits the button from being depressed when the locking mechanism is in a locked state.

### TECHNICAL FIELD

The invention generally relates to a locking mechanism for locking a handle of a rollable suitcase.

### BACKGROUND

Traditionally, rollable suitcases have extendable handles that extend and contract from the suitcase. The handle is useful for pulling luggage around airports, train stations, etc. Rollable suitcases have gained popularity as travelers no longer need to lift and carry potentially heavy suitcases long distances. As these types of suitcases grow in popularity, there is an increasing chance that travelers will mistake their own bag from a similar looking bag. Additionally, because there may be times when travelers are away from their suitcases, (e.g., suitcases arrive at a baggage claim area of an airport terminal before the traveler deplanes and arrives at the terminal to pick up suitcases, missed connecting flights, etc.) it is relatively for a thief to simply pick up a stranded suitcase and roll the suitcase away.

### BRIEF DESCRIPTION OF THE DRAWINGS

FIG. 1A shows a locking mechanism disposed on an extendable handle of a suitcase according to embodiments.

FIG. 1B is a close-up view of locking mechanism disposed on an extendable handle of a suitcase according to embodiments.

FIG. 2A shows a locking mechanism for locking an extendable handle of a rollable suitcase according to embodiments.

FIG. 2B is a close-up view of a locking mechanism for locking an extendable handle of a rollable suitcase according to embodiments.

FIG. 3 is an alternative embodiment showing locking mechanism disposed on an extendable handle according to embodiments.

FIG. 4 shows a locking mechanism for locking an extendable handle and wheels of a rollable suitcase according to embodiments.

FIG. 5 is a flow chart describing a process for locking an extendable handle of a suitcase according to embodiments.

### DETAILED DESCRIPTION

This disclosure will now more fully describe exemplary embodiments with reference to the accompanying drawings, in which specific embodiments are shown. Other aspects may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements are shown throughout are indicated with like reference numerals.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “extendable handle” means a handle, coupled to at least one arm, may be moved from an extended position to a retracted position and from a retracted position to an extended position.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

Described herein is a suitcase having a locking mechanism disposed on the handle of the suitcase according to embodiments. The suitcase has a plurality of wheels disposed on a distal end. A casing is at least partially disposed on a first side of the suitcase. At least one extendable arm is slideably coupled to the casing and the arm is configured to move between a retracted position and an extended position. A handle is coupled to the at least one arm and a button is disposed on the handle. When the button is depressed, the handle can be moved from the retracted position to an extended position. A locking mechanism is also disposed on the handle which prohibits the button from being depressed when the locking mechanism is in a locked state.

In another embodiment, a rollable suitcase is disclosed having a set of wheels disposed on a bottom portion of the suitcase. An extendable handle is coupled to at least one arm and is configured to move from a retracted position to an extended position. A locking mechanism is disposed on the handle. The locking mechanism is configured to prohibit the extendable handle from moving from a retracted position to an extended position when the locking mechanism is in a locked state.

In still yet other embodiments, a method for locking an extendable handle of a rollable suitcase is disclosed. According to embodiments, the extendable handle of the rollable suitcase is moved from an extended position to a retracted position. A locking mechanism, disposed on the handle of the rollable suitcase, may be locked. The locking action prohibits the extendable handle from moving from the retracted position to the extended position.

Identification of personal luggage and suitcases at airports, train stations and other such transportation mediums can be difficult because many suitcases may look or be similar. Having a locking mechanism disposed on the handle, or alternatively near the handle, may be useful in identifying personal luggage. For example, if a traveler mistakes a similar looking bag for his/her own and is unable to extend an extendable handle due to a locking mechanism, the traveler instantly knows he/she grabbed the wrong suitcase. Additionally, a locking mechanism, such as the one described herein, may deter thieves from taking baggage that has been placed or left in a baggage claim area of an airport as the thief would potentially have to carry the suitcase instead of roll it.

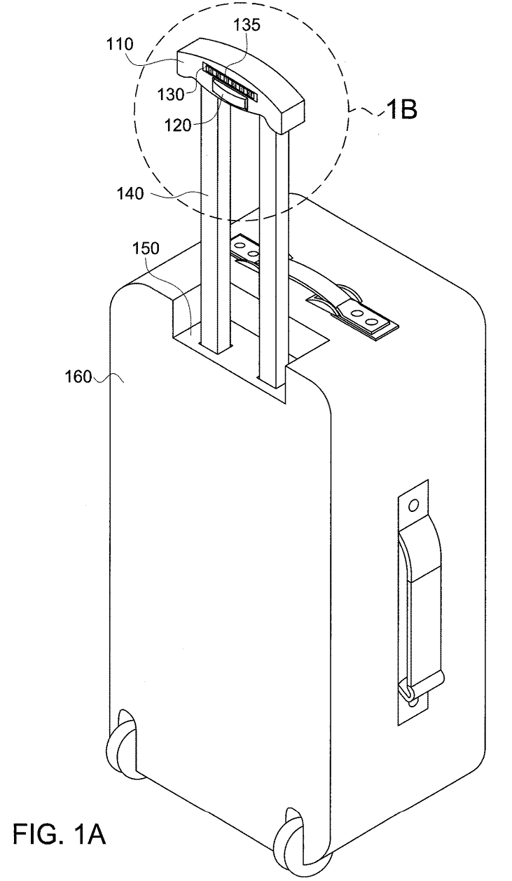

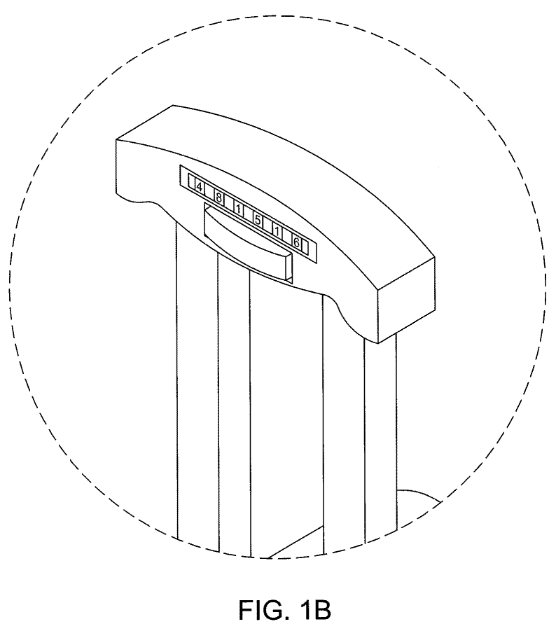

FIG. 1A shows a locking mechanism 130 disposed on an extendable handle 110 of a suitcase 160 according to embodiments. The extendable handle 110 is coupled to the arms 140 of the suitcase 160. The arms 140 are configured to slide through an opening in a casing 150 that is disposed, at least partially, on a top portion of the suitcase. The casing 150 is also configured to enable the arms 140 to slide through the casing via openings in the casing 150. According to embodiments, the arms are configured to move the handle from a retracted position to an extended position. When in the retracted position, the arms 140 are substantially, if not entirely, contained within a portion of the suitcase 160. Embodiments provide the arms may be telescopic.

The extendable handle 110 has a button 120 which, when depressed, enables the arms 140 of the suitcase 160 to move from the retracted position to an extended position and vice versa. The extendable handle 110 also has a locking mechanism 130 disposed thereon. The locking mechanism 130 can be changed from a locked state to an unlocked state and vice versa. When in the locked state, the locking mechanism 130 prohibits the button 120 from being depressed, which in turn, prohibits the extendable handle 110 and arms 140 from being moved from a retracted position to an extended position.

Although FIG. 1A shows the button 120 and the locking mechanism 130 on a back portion of the handle, it is contemplated that the button and locking mechanism can be disposed on any place on the handle 110. For example, the button 120 and locking mechanism 130 can be located on the top planar surface of the handle 110. Alternatively, a button or plurality of buttons can be located on a bottom planar surface of the handle 110 while the locking mechanism is located on the top planar surface of the handle 110. Although specific examples have been given, it is contemplated that the button 110 and locking mechanism 130 can be located adjacent to or separate from each other on any portion of the handle. 110.

According to embodiments, the locking mechanism 130 may be a combination lock, such as shown in FIG. 1A. The combination lock may consist of a plurality of dials 135. The dials may have numbers or letters that can be used to select different combinations. To unlock the locking mechanism 130, the dials 135 must be rotated or moved to reflect a correct combination. For example, the combination may be set as 4, 8, 1, 5, 1, 6. When the dials 135 have been set to this combination, the locking mechanism 130 enables the button 120 to be depressed. Once depressed, the button releases the extendable handle 110 and the extendable handle 110 may be moved from a contracted position to an extended position.

FIG. 1B is a close-up view of locking mechanism 130 disposed on an extendable handle 110 of a suitcase 160 according to embodiments. As described above, the locking mechanism 130 may be a combination lock having a plurality of dials 135. The dials may contain any number of digits (e.g., 0-9) with the order of the digits forming a combination. When the dials reflect the predetermined combination, the button 120 on the handle may be depressed which enables the extendable handle 110 to be moved from a retracted position to an extended position.

It is also contemplated that the locking mechanism and button may be used to lock the extendable handle in an extended position. In such an embodiment, when the extendable handle is in an extended position, the locking mechanism may be set to a locked state. When in the locked state, the locking mechanism prevents the button from being depressed, which in turn may prevent the extendable handle from moving from an extended position to a retracted position.

Other embodiments provide that the locking mechanism is a bolt and key lock. Although specific embodiments are described, it is contemplated that any form of locking mechanism that would prohibit or enable a button, such as for example button 120, being depressed may be used.

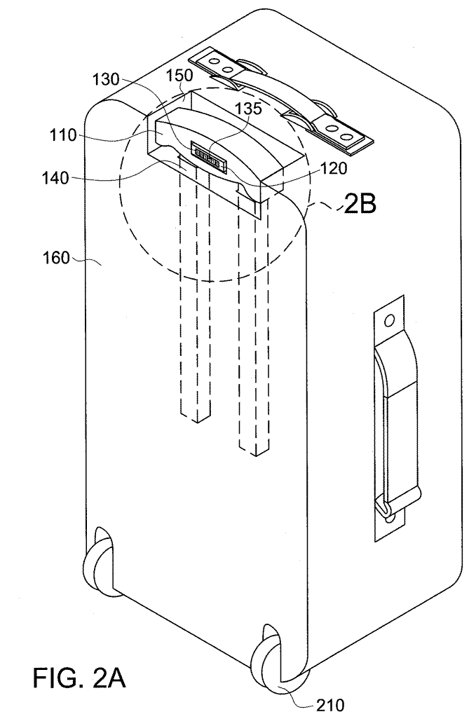

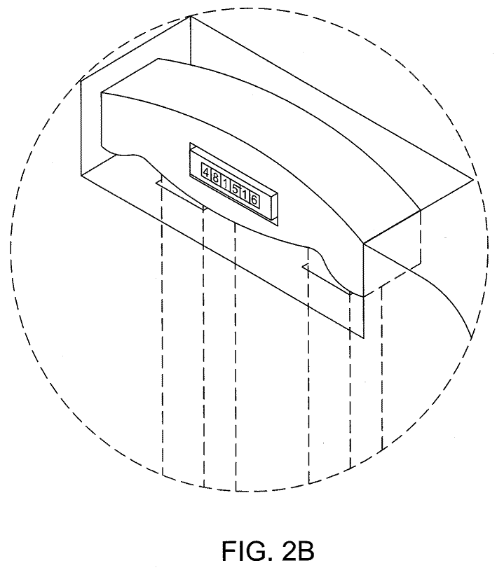

FIGS. 2A-5 illustrate various aspects and features of a locking mechanism 130 disposed on an extendable handle 110 according to embodiments. FIGS. 2A-5 also show components that were first described with respect to FIG. 1A and therefore the description of FIGS. 2A-5 may refer to at least one component described in FIG. 1A. However, any references to components of FIG. 1A are for descriptive purposes only.

FIG. 2A shows a suitcase 160 having an extendable handle 110 with a locking mechanism 130 disposed thereon. According to embodiments, suitcase 160 may also have a set of wheels 210 positioned on a bottom portion of the suitcase 160. The extendable handle 110, along with the set of wheels 210 may be used by a traveler to roll a rollable suitcase such as suitcase 160. As will be discussed in greater detail below, a locking mechanism may be used to lock the set of wheels 210 and prevent the wheels from rolling. Other embodiments provide that the wheels may be removable as an added security feature.

The suitcase 160 also includes casing 150 disposed on a top portion of the suitcase 160. When the extendable handle 110 is in a contracted position, as shown by FIG. 2, the arms 140 are substantially contained within a portion of the suitcase 160. Additionally, the extendable handle 110 is at least partially enclosed by the casing 150. The casing may protect the handle from being damaged while at the same time protecting the locking mechanism 130 from being damaged during transportation.

According to embodiments, the extendable handle 110 has a button 120 disposed thereon. The button 120 may be located on top of the handle, at the bottom of the handle or on a side of the handle. The button 120 controls the extension and retraction of the extendable handle 110. For example, when the button 120 is depressed, an upward force may be exerted on the extendable handle 110. As a result of the combination of the button being depressed and the upward force, the extendable handle 110 moves in the upward direction from a retracted position to an extended position.

Although specific examples discussed herein disclose a button that is depressed, it is contemplated that any type of button, switch, or knob may be used along with a locking mechanism to control the extension and retraction of an extendable handle of a suitcase.

Embodiments provide that the locking mechanism 130 is placed directly on a button 120. Other embodiments provide that the locking mechanism 130 is disposed on the handle near the button. Still yet other embodiments provide that a locking mechanism 130 may be disposed on the casing 150 and lock the arms 140 in a retracted position. As previously discussed, the locking mechanism may be a combination type lock having a plurality of dials 135 that are used to input various number and/or letter combinations into the locking mechanism 130. When the correct combination is shown on the plurality of dials 135, the button may be depressed and the extendable handle 110 may be extended.

FIG. 2B is a close-up view of a locking mechanism 130 for locking an extendable handle 160 of a rollable suitcase 160 with the locking mechanism 130 being disposed directly on the button 120 according to embodiments.

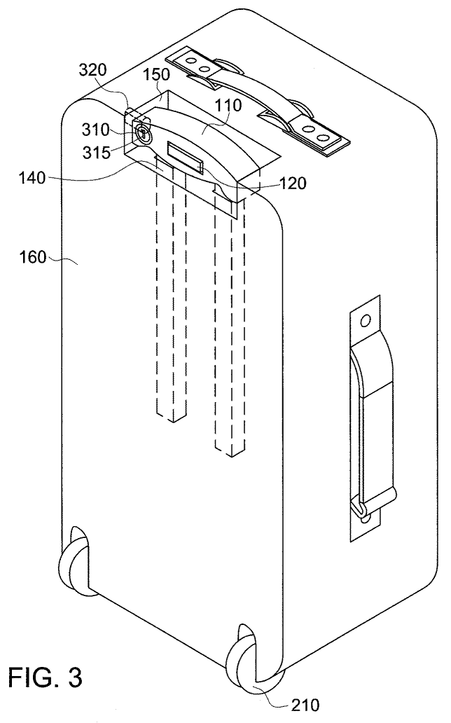

FIG. 3 shows an extendable handle 110 for a suitcase 160 having a locking mechanism 310 disposed thereon according to embodiments. As shown in FIG. 3, a locking mechanism 310 may be disposed on an extendable handle 110 of a suitcase 160. According to embodiments, the locking mechanism 310 may be a bolt and key locking mechanism that includes a key hole 315 and a bolt 320. The bolt 320 may be contained within the handle 110 of the suitcase 160 when the locking mechanism 310 is in an unlocked position. When a key is inserted into the key hole 315 of the locking mechanism 310 and turned, the bolt 320 slides, at least partially, out of the handle 110 and is inserted into an opening in the casing 150 configured to receive the bolt 320. According to embodiments, when the locking mechanism 310 is in a locked position, the button 120 may still be depressed, however the bolt 320 will prevent the extendable handle 110 from being moved to an extended position.

In alternative embodiments, a locking mechanism, such as locking mechanism 310 may be placed near the set of wheels 210 (or a single wheel of the set of wheels) positioned at a bottom portion of the suitcase 160. When the locking mechanism 310 is in the locked position, the bolt 320 moves from a retracted position to an extended position and locks the wheels.

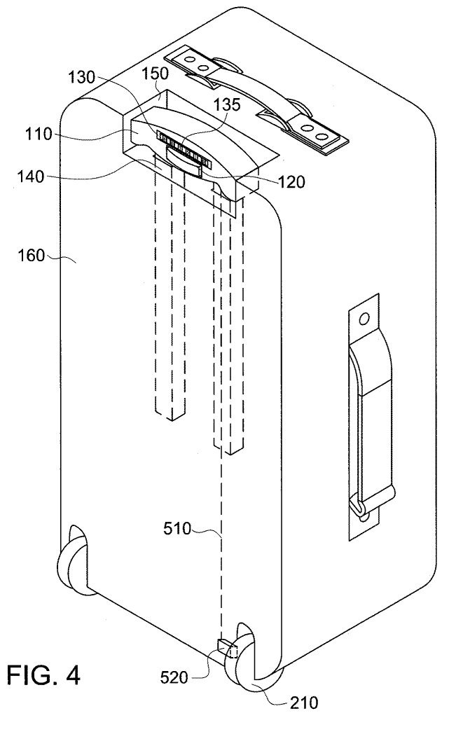

FIG. 4 shows a locking mechanism 130 disposed on an extendable handle 110 of a suitcase 160 with a corresponding wheel locking mechanism 520 according to embodiments. The extendable handle 110 may have a button 120 disposed on a portion of the extendable handle 110. The button 120 is configured to control when the extendable handle 110 can be moved from a retracted position to an extended position. The button may be locked by a locking mechanism 130. The locking mechanism 130 may be a combination lock having a plurality of dials 135. Alternatively, the locking mechanism may be a bolt and key lock.

According to embodiments, a wheel locking control mechanism 510 controls whether the wheel locking mechanism 520 is engaged or disengaged. According to embodiments, the wheel locking control mechanism may be coupled to arms 140 of the suitcase 160. As the arms 140 move from a retracted position to an extended position, the wheel locking control mechanism 510 disengages the wheel locking mechanism 520. As arm 140 is moved from the extended position to the retracted position, the wheel locking control mechanism 510 engages the wheel locking mechanism 520.

Alternatively, the wheel locking control mechanism 510 may be coupled to the extendable handle 110. In such embodiments, when the extendable handle 110 moves from a retracted position to an extended position, the wheel locking control mechanism 510 disengages the wheel locking mechanism 520 and the wheels are able to roll. As the extendable handle 110 is moved from the extended position to the retracted position, the wheel locking control mechanism 510 engages the wheel locking mechanism 520 and the wheels are locked once again.

In still yet other embodiments, the wheel locking control mechanism 510 may be placed inside a housing in which the arms 140 are slideably coupled. When a bottom end of the arms 140, as they are being moved from an extended position to a contracted position, come into contact with the wheel locking control mechanism 510, a switch is triggered which engages the wheel locking mechanism 520. When the arms 140 are moved from the retracted position to an extended position, the wheel locking control mechanism is triggered again and disengages the wheel locking mechanism 520. Thus, the wheel locking control mechanism 510 controls whether the set of wheels, or a single wheel, is locked or unlocked.

In embodiments, the wheel locking mechanism 520 cannot be extended and retracted without the extendable handle 110 being moved from retracted position to an extended position. Thus, when the locking mechanism 130 is in a locked state and prevents a button 120 from being depressed, the locking mechanism 130 also controls whether the wheel locking mechanism 520 is engaged.

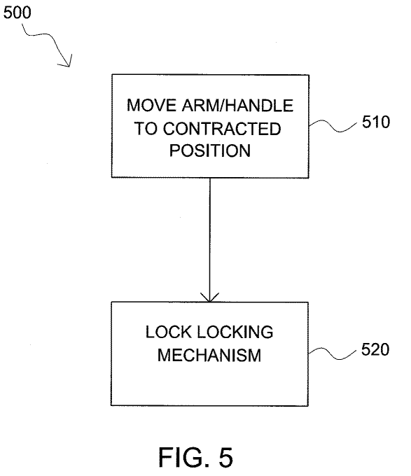

FIG. 5 is a flow chart describing a process 500 for locking a handle of a suitcase according to embodiments. Step 510 provides that an extendable handle of a suitcase, is placed in a retracted position. When in the retracted position, at least one arm of the suitcase, being coupled to the extendable handle, is substantially contained within the suitcase. Accordingly, the handle may be enclosed, at least partially, within a casing of the suitcase.

Step 520 provides that a locking mechanism disposed on the extendable handle is locked. The locking mechanism may be locked by inserting and turning a key to a locked position. Alternatively, the locking mechanism may be a combination lock. The locking mechanism prohibits the handle from being moved from the retracted position to an extended position. According to embodiments, the locking mechanism may prevent a button, a plurality of buttons, a lever, a switch or a knob from being triggered and moving the extendable handle from a retracted position to an extended position. Thus, because the button cannot be depressed, the extendable handle cannot be extended.

To enable the extendable handle to move from the retracted position to the extended position, the locking mechanism may be unlocked. The locking mechanism may be unlocked by either inserting and turning the key or by entering the correct combination depending on the implementation. Once unlocked, the button may be depressed and the handle moved from the retracted position to the extended position. Alternative embodiments provide that the locking mechanism such may also control a wheel locking mechanism such as described above with respect to FIG. 4.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A suitcase comprising:
a plurality of wheels disposed on a distal end of the suitcase;
a casing at least partially disposed on a first side of the suitcase;
an extendable handle coupled to at least one arm, wherein the at least one arm is slideably coupled to the casing and wherein the at least one arm is configured to move the extendable handle between a retracted position and an extended position;
a button disposed on the extendable handle, wherein when the button is depressed the extendable handle can move from the retracted position to the extended position; and
a locking mechanism disposed on the extendable handle, wherein when the locking mechanism is in a locked state, the locking mechanism prohibits the button from being depressed.

2. The suitcase of claim 1, further comprising a wheel locking mechanism configured to lock the plurality of wheels when the locking mechanism is in the locked state.

3. The suitcase of claim 1, wherein the locking mechanism is configured to prohibit the at least one arm from slideably moving within a housing at least partially contained within the suitcase.

4. The suitcase of claim 3, wherein the locking mechanism is configured to lock the plurality of wheels when the extendable handle is in the retracted position.

5. The suitcase of claim 1, wherein the locking mechanism is a combination lock.

6. The suitcase of claim 1, wherein the locking mechanism is a bolt and key lock.

7. The suitcase of claim 6, further comprising an opening on at least one side of the casing, wherein the opening is configured to receive at least a portion of a bolt of the bolt and key lock.

8. The suitcase of claim 1, wherein the at least one arm is a telescoping arm.

9. A rollable suitcase comprising:
a set of wheels disposed on a bottom portion of the rollable suitcase;
at least one arm slideably engage to a portion of the rollable suitcase;
an extendable handle coupled to the at least one arm; and
a locking mechanism disposed on the extendable handle, wherein the locking mechanism is configured to prohibit the extendable handle from moving from a retracted position to an extended position when the locking mechanism is in a locked state.

10. The rollable suitcase of claim 9, further comprising a wheel locking mechanism configured to lock the set of wheels when the locking mechanism is in a locked state.

11. The rollable suitcase of claim 9, further comprising a casing, wherein the casing is disposed on a top portion of the rollable suitcase and wherein the casing is configured to store the extendable handle of the rollable suitcase when the extendable handle is in the retracted position.

12. The rollable suitcase of claim 11, wherein the locking mechanism is disposed on the casing, and wherein the locking mechanism locks the extendable handle in the retracted position.

13. The rollable suitcase of claim 11, wherein the locking mechanism is a bolt and key lock and wherein a bolt of the bolt and key lock is slideably coupled to the extendable handle and wherein the casing is configured to receive at least a portion of the bolt when the locking mechanism is in a locked state.

14. The rollable suitcase of claim 11, further comprising a locking mechanism disposed on the bottom portion of the rollable suitcase, wherein the locking mechanism disposed on the bottom portion of the rollable suitcase is configured to lock at least one wheel of the set of wheels.

15. The rollable suitcase of claim 14, wherein the locking mechanism disposed on the bottom portion of the rollable suitcase is a bolt and key lock.

16. A method of locking a rollable suitcase comprising:
moving an extendable handle of the rollable suitcase from an extended position to a retracted position; and
locking a locking mechanism disposed on the rollable suitcase, wherein when the locking mechanism is locked, the locking mechanism prohibits the extendable handle from moving from the retracted position to the extended position.

17. The method of claim 16, wherein the locking mechanism is disposed on the extendable handle.

18. The method of claim 17, further comprising, prohibiting a button disposed on the extendable handle from being depressed when the locking mechanism disposed on the handle is in a locked state.

19. The method of claim 16, wherein the locking mechanism is a combination lock.

20. The method of claim 16, further comprising locking, with the locking mechanism, at least one wheel of a set of wheels of the rollable suitcase.
